(19) United States
(12) Patent Application Publication
(10) Pub. No.: US 2006/0196608 A1
(43) Pub. Date: Sep. 7, 2006

(54) Fastener tape supply unit of fastener stringer continuous manufacturing apparatus

(76) Inventors: Akinobu Terasawa, Toyama-ken (JP); Kazuyoshi Nishida, Toyama-ken (JP)

Correspondence Address: Michael S. Leonard;Everest Intellectual Property Law Group, P.O. Box 708, Northbrook, IL, 60065, US

(21) Appl. No.: 11/364,618

(22) Filed: Feb. 28, 2006

(30) Foreign Application Priority Data
Mar. 2, 2005 (JP) 2005-57956

(51) Int. Cl. B32B 37/00

(52) U.S. Cl. 156/361; 156/543

(57) ABSTRACT

The invention provides a fastener tape supply unit applied to a continuous manufacturing apparatus for a fastener stringer, wherein a dancer roller moving up and down corresponding to changes in tape tension is loaded on a fastener tape carried between a feed roller portion for feeding the fastener tape continuously and positively and an engaging element implantation portion, upper and lower limit positions of the dancer roller are detected by detecting means, and when the dancer roller goes out of a range defined by the upper limit position and the lower limit position, a corresponding detection signal is sent to a control portion, the control portion outputs an instruction signal for always holding the dancer roller between the upper and lower limit positions to a drive portion of a drive roller, thereby controlling a tape feeding amount of the feed roller portion to be always constant.

### BACKGROUND OF THE INVENITON

1. Field of the Invention

The present invention relates to a fastener tape supply unit applicable to a continuous manufacturing apparatus for a fastener stringer for attaching an engaging element for a slide fastener to a fastener tape supplied intermittently, wherein the slide fastener is obtained by cutting, in a direction of its lateral section, an engaging element linear material having a substantially Y-shaped section formed by multi-stage rolling.

2. Description of the Related Art

For this kind of engaging element for slide fastener, a long metallic linear material having a circular section is formed into a substantially Y shape in its lateral section through a plurality of mill rolls, and sequentially cut into a predetermined thickness with a cutting punch and a cutting die to obtain individual engaging element materials. Then, its engaging element head is formed into a mountain-like shape with a forming punch and a forming die to obtain an engaging element (hereinafter referred to as linear-material-made engaging element). A forming method for such a linear-material-made engaging element has been disclosed in, for example, EP-A-0028358. In the engaging element after this forming is completed, its attaching legs are clamped with a clamping hammer and are sequentially attached to an engaging element attaching portion of a fastener tape at a predetermined pitch.

Thus, a conventional fastener tape supply unit, for example, disclosed by Japanese Patent Publication No. S59-51813, is provided with an intermittent feeding portion for feeding a fastener tape intermittently to a downstream side of the engaging element attaching portion at the above-mentioned pitch when formation of the engaging element is completed. However, when engaging elements are attached to the fastener tape in succession, the engaging elements cannot be attached to the fastener tape at an equal pitch even if the fastener tape is fed intermittently at an equal pitch. For this reason, as per conventional, when supply of the fastener tape is interrupted, it is important to apply a predetermined tension to the fastener tape in an upstream of the intermittent feeding portion and to maintain the tension at a constant level. In order to maintain the constant tension, as is conventionally done, a fastener tape is also guided with a spring guide disposed on a carrying passage for the fastener tape, thereby absorbing changes in tension of the fastener tape by the spring force. Or, a so-called dancer roller having a predetermined weight is placed on the fastener tape such that it moves up and down freely depending on the weight of the roller. Further, a feed roller portion which rotates at a constant speed may be disposed at an upstream side of the fastener tape with respect to the dancer roller.

By the way, a fastener tape supplied continuously at a time of manufacturing of the fastener stringer is extremely long, and the tape supply unit often operates continuously for a long time, for example, several hours to several dozen hours at a time. On the other hand, the fastener tape is generally constituted of textile woven fabric or knit fabric, and there is no warranty that it is completely uniform in quality throughout an entire length. Moreover, its physical property is likely to change due to influences of humidity and temperature. Furthermore, a core thread is usually integrally attached to an engaging element attaching portion of a fastener tape for attaching the linear-material-made engaging element. Thus, a thickness of the core thread is added to that of the fastener tape itself at a portion having the core thread attached, thereby causing a delicate change in feeding speed of the fastener tape by the feed roller portion and the intermittent feeding portion. Further, a feeding amount of the fastener tape is changed delicately by an influence by, for example, slippage at the feed roller portion as well.

Although the change in feeding amount is not so large, this grows to a large change in a tremendously large total length by operation for a long time, so that, for example, tape tension increases gradually during the operation, thereby exceeding the weight of the dancer roller. Alternatively, the feeding amount from the feed roller portion increases gradually and finally the fastener tape slackens between the feed roller portion and the intermittent feeding portion, without supporting the dancer roller. Consequently, the fastener tape is deposited there and tension adjustment which is an initial purpose becomes impossible, thereby leading a condition in which stopping the manufacturing is unavoidable.

### SUMMARY OF THE INVENTION

The present invention has been achieved to solve such a problem, and an object of the invention is to provide a fastener tape supply unit in which a tension of a fastener tape at an engaging element attaching portion can be always adjusted automatically within a predetermined tension range, in a fastener stringer continuous manufacturing apparatus which attaches linear-material-made engaging elements produced intermittently to a fastener tape supplied intermittently in synchronism.

In order to achieve the above-described object, the present invention provides a fastener tape supply unit of a continuous manufacturing apparatus for a fastener stringer for successively attaching attaching legs of engaging elements for a slide fastener obtained by cutting a metallic linear material having a substantially Y shaped section supplied intermittently at right angle and by forming into a mountain-like shape to a fastener tape supplied intermittently at a predetermined pitch to a clamping portion, the fastener tape supply unit including: a supply source of the fastener tape; a feed roller portion for feeding the fastener tape positively and continuously from the supply source; a dancer roller which is hung by the fastener tape fed continuously between the feed roller portion and an engaging element implantation portion and moves up and down corresponding to changes in tape tension; an intermittent feeding portion which is disposed in a downstream of the fastener tape of the engaging element implantation portion and feeds the fastener tape intermittently, detecting means for detecting a move upper limit position and a move lower limit position of the dancer roller; and a control portion for, when the detecting means detects that the dancer roller reaches the move upper limit position and the move lower limit position or when the detecting means detects that the dancer roller escapes from a range defined by the move upper limit position and the move lower limit position, controlling a tape feeding amount of the feed roller portion so as to always keep the dancer roller within the range based on a detection signal.

According to a preferred embodiment, the dancer roller is rotatably supported via a supporting shaft at one end of a swing member whose the other end is journaled at a fixed position, and the detecting means comprises a rotary encoder disposed at the one end of the swing member.

The metallic linear material for the engaging element having a desired section which is supplied intermittently at a predetermined pitch is subjected to multi-stage rolling to be formed into an entirely smooth substantially Y-shaped section, and then, the linear material is fed upward intermittently by an amount corresponding to a single engaging element. When the feeding of the linear material is completed, the linear material is projected from the cutting die by a length corresponding to a thickness of a single engaging element. Next, the cutting die begins to retract, a projected portion of the linear material is cut with the cutting punch and the engaging element is moved from the cutting die to the forming die at a rear end stop position of the cutting die. At this time, a clamp hammer is in a halt state and the forming die supports the attaching legs of the engaging element from both sides to regulate a horizontal movement of the engaging element.

Thereafter, as the forming punch lowers, a pressure pad also lowers so as to form the engaging head into a mountain-like form. Next, the cutting die and the forming die advance in cooperation, and then, a pair of right and left clamping punches begin to operate, so that the attaching legs of the engaging element are clamped by a clamping faces formed on the clamping punchs and consequently deformed in a direction of approaching each other. After the engaging element is attached to an engaging element attaching portion of a fastener tape supplied intermittently and kept in standby condition, the intermittent feeding unit is actuated so that a next engaging element attaching portion of the fastener tape is fed to the clamping portion of the clamping punch. On the other hand, the fastener tape is fed continuously from a feed roller disposed in an upstream of the fastener tape. An amount of the fastener tape fed out from the feed roller portion at this time is set preliminarily, and a drive roller of the feed roller portion is rotated at a constant speed to feed the fastener tape by a constant amount.

However because the fastener tape is usually constituted of textile woven fabric or knitted fabric, it cannot be manufactured completely uniformly in an entire length of such a long fastener tape. Further, physical property of such fastener tape is likely to change depending on a surrounding work environment, and furthermore, a core thread is attached by sewing, weaving or knitting along the engaging element attaching portion of the fastener tape to be equipped with the linear-material-made engaging elements. Moreover, the fastener tape is usually accommodated in a can such that it is coiled in whorls, and pulled up positively by the feed roller portion through a guide or the like and fed to the intermittent feeding portion. The dancer roller is interposed between the feed roller portion and the intermittent feeding portion so as to hold the tension of the fastener tape at a constant level. When the fastener tape is pulled out from the state in which it is accommodated in the can in whorls as described above, the pulled tape is often twisted.

A speed of a fastener tape fed out from the feed roller portion changes because slippage occurs in the feed roller portion, the fastener tape is fed to the feed roller portion in a twisted state, or the fastener tape is elongated or contracted due to combination of such various factors. A tension change due to this speed change is extremely small if observed in a short time and usually can be adjusted sufficiently with only the dancer roller. However, slight changes are accumulated if the supply unit is operated continuously for a long time, so that tape feeding at an initial time of the feeding deflects to one side. Consequently, the tension cannot be held at a constant level even if the tension is adjusted corresponding to the weight of the dancer roller. Moreover, the physical property often changes depending on an operation day or among fastener tapes manufactured under different conditions even if a same kind of the fastener tape is employed, thereby causing a change in feeding amount from the feed roller portion.

Thus, according to the present invention, as described above, the position detecting means is disposed at upper and lower move positions of the dancer roller, and when its detection value reaches an upper limit or a lower limit of the upper and lower move positions or escapes from the upper limit or lower limit, a signal is sent to a drive portion of the feed roller portion through the control portion, thereby controlling a rotation speed of the drive roller. For example, when the dancer roller exceeds its upper limit position, the feeding amount of the fastener tape is increased by raising the rotation speed of the drive roller. When the dancer roller moves below the lower limit position, the feeding amount of the fastener tape is decreased by lowering the rotation speed of the drive roller. As a result, the tape tension between the intermittent feeding portion and the feed roller portion can be always kept constant, particularly when the engaging element is attached in which the fastener tape is stopped, even in the continuous operation for a long time. If it is warranted to hold the tension of the fastener tape at a constant level at the time of attachment of the engaging element in this way, an attachment interval (pitch) of the engaging elements is made uniform, thereby obtaining a high quality fastener stringer.

As for the detecting means, for example, a limit switch or a photoelectric tube can be used. However, preferably, a rotary encoder is mounted on a proximal end of swing of a swing lever as described above, and a swing range of the dancer roller supported rotatably at a front end of the swing lever is detected by the rotary encoder and its detection signal is sent to the control portion. Consequently, mechanical motion can be securely converted to an electric signal, so that durability of the apparatus is improved and transmission of signals becomes extremely accurate, thereby improving reliability in detection accuracy and further control accuracy.

### BRIEF DESCRIPTION OF THE DRAWINGS

FIG. 1 is a perspective view showing major portions of an engaging element forming apparatus for a slide fastener, to which the present invention is applied;

FIG. 2 is a longitudinal sectional view of an engaging element forming portion of the same apparatus;

FIG. 3 is a schematic configuration view schematically showing a fastener tape supply unit according to a preferred embodiment of the present invention; and

FIG. 4 is a perspective view showing the schematic configuration of the fastener tape supply unit.

### DESCRIPTION OF THE PREFERRED EMBODIMENTS

Hereinafter, a preferred embodiment of the present invention will be described specifically with reference to the accompanying drawings.

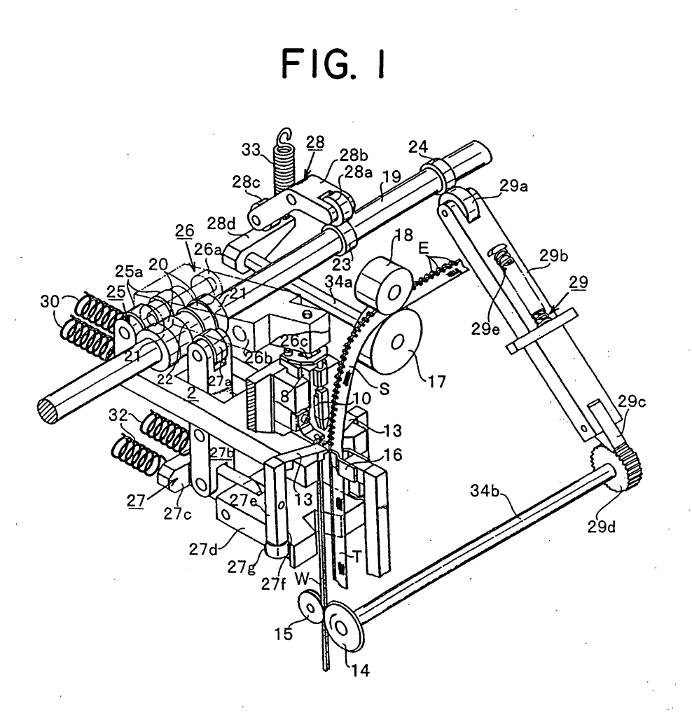

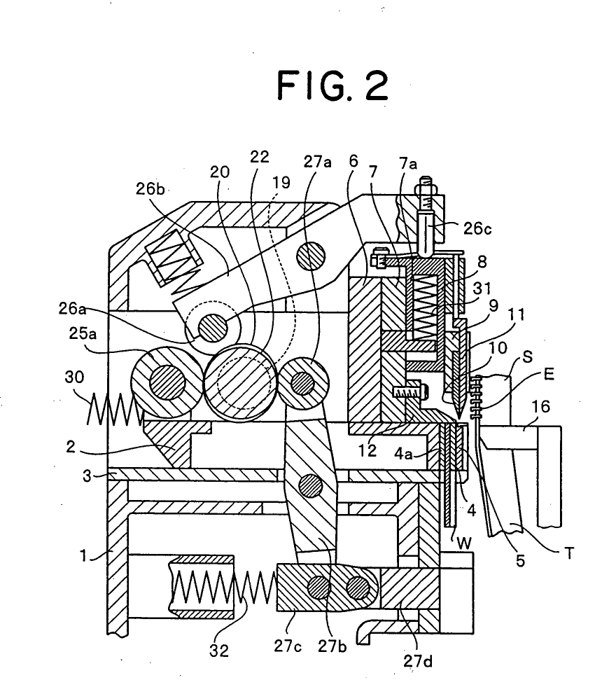

FIGS. 1 and 2 schematically show an example of major portions of an engaging element forming apparatus for a slide fastener, to which a fastener tape supply unit of the present invention is applied. An indicated structure of the apparatus is not substantially different from the apparatus disclosed in Japanese Patent Publication No. 59-51813. Thus, a following outline of the apparatus is based on description of the publication. In these figures, a first ram 2 is supported on a base 1 through a ram guide 3 so as to freely reciprocate horizontally, and a cutting die 4 and a forming die 5 are provided on a front portion of the first ram 2 in this order in an advancement direction of the first ram 2. The cutting die 4 has an introduction passage 4a for introducing an engaging element irregular shape linear material W having, for example, a Y-shaped lateral section. The forming die 5 is for forming an engaging head of an engaging element E.

A set plate 6 supported by the base 1 is disposed above a front end of the first ram 2, and a ram guide 7 is mounted on the set plate 6. A second ram 8 is provided on the ram guide 7 so as to be capable of moving up and down vertically with respect to a horizontal reciprocation of the first ram 2. A forming punch 10 for forming the engaging head of the engaging element E and a pressure pad 11 for pressing both attaching legs of the engaging element E at a time of forming the engaging head are mounted on a front face of the second ram 8 through a punch holder 9. A cutting punch 12 capable of making sliding contact with a top face of a front portion of the first ram 2 is fixed on a bottom end of the ram guide 7. A pair of clamping punches 13 is provided on both sides of the forming die 5, so that the attaching legs of the engaging element E after its engaging head is formed are clamped from both right and left sides, so as to attach the engaging element E to a fastener tape T.

As shown in FIG. 1, an engaging element linear material W having a Y-shaped section is intermittently supplied by an amount corresponding to a thickness of a single engaging element E by feed rollers 14, 15 to the insertion hole 4a for the linear material in the cutting die 4. The fastener tape T is supplied from below and guided by a tape guide 16, in which the fastener tape T becomes a slide fastener stringer S with the engaging element E attached. The slide fastener stringer S is intermittently pulled by an intermittent drive roller 17 and a pressure roller 18 of an intermittent feeding portion.

A drive main shaft 19 is provided above a rear portion of the first ram 2, and a first ram drive cam 20, a forming punch actuating cam 21, a clamping punch actuating cam 22, a stringer feeding cam 23 and a linear material feeding cam 24 are provided on the main shaft 19. The respective cams 20 to 24 are respectively connected to the first ram 2, the forming punch 10, the clamping punch 13, the intermittent drive roller 17 and the linear material feed roller 14 via cam driven mechanisms 25 to 28, and these components are actuated.

The cam driven mechanism 25 of the first ram 2 has a first roller 25a which makes a rolling contact with the first ram drive cam 20, and the roller 25a is journaled at the rear portion of the first ram 2. The first ram 2 is urged in a forward direction by a compression spring 30, and is horizontally reciprocated by a rotation of the first ram drive cam 20. Further, a cam face of the first ram drive cam 20 is constructed so as to stop the first ram 2 for a predetermined time at its front end position and rear end position.

On the other hand, the cam driven mechanism 26 of the forming punch 10 comprises a second roller 26a, a lever 26b, a pin 26c, and a compression spring 26d. The second roller 26a makes a rolling contact with the forming punch actuating cam 21. The roller 26a is journaled at one end of the lever 26b, and a central portion of the lever 26b is mounted on an apparatus main body via a shaft. The pin 26c is attached to the other end of the lever 26b, and makes contact with a head of the second ram 8. The compression spring 26d returns the lever 26b. The second ram 8 incorporates a compression spring 31 for urging the ram upward, and the lever 26b swings by the cam 21 so that the second ram 8 lowers and this returns to its original position by the compression spring 31.

The cam driven mechanism 27 of the clamping punch 13 comprises a third roller 27a, a lever 27b, a link 27c, a third ram 27d, and actuating levers 27e. The third roller 27a makes a rolling contact with the cam 22. The lever 27b journals the roller 27a on a top end thereof, extends downward, and is supported on the base I via a shaft at a central portion thereof. A central portion of the link 27c is supported at a bottom end of the lever 27b via a shaft. The third ram 27d has a front end of the link 27c connected to a rear portion thereof via a shaft. The clamping punch 13 makes contact with a top of the actuating levers 27e, and a central portion of the actuating levers 27e is connected via a shaft. As shown in FIG. 1, a side face at a front end of the third ram 27d is formed as a cam face 27f extending outward, and a cam receiver 27g is provided at a bottom end of the actuating lever 27e. When the third ram 27d is retracted by the cam face 27f and the cam receiver 27g, the actuating lever 27e swings so as to actuate the clamping punch 13. Restoration of the third ram 27d to its original position is carried out by a compression spring 32.

As shown in FIG. 1, the cam driven mechanism 28 for feeding a stringer comprises: a fourth roller 28a which makes a rolling contact with the stringer feeding cam 23; a first lever 28b in which the roller 28a is journaled at one end thereof and a fifth roller 28c is journaled at the other end thereof and whose central portion is supported via a shaft; and a second lever 28d which swings downward by a sixth roller 28e and is urged upward by a pulling spring 33. A transmission shaft 34a of the intermittent drive roller 17, in which a single-direction clutch (not shown) is mounted on an intermediate portion thereof, is connected to a proximal end of the second lever 28d, so that the intermittent drive roller 17 is intermittently rotated only in a single direction so as to feed the fastener stringer S.

The cam driven mechanism 29 for feeding a linear material comprises: a seventh roller 29a which makes a rolling contact with the cam 24; a slider 29b having the seventh roller 29a supported via a shaft at one end thereof; a ratchet 29c attached to the other end of the slider 29b; and a ratchet wheel 29d which is intermittently rotated only in a single direction by a predetermined angle by the ratchet 29c. In this manner, the ratchet wheel 29d and the linear material feeding roller 14 are connected with each other via a transmission shaft 34b, so that the linear material feeding roller 14 intermittently supplies the linear material W. Restoration of the slider 29b to its original position is carried out by a compression spring 29e.

When advancement of the first ram 2 stops, feeding of the irregular shape linear material W is completed, so that the irregular shape linear material W is projected over the cutting die 4 by a predetermined thickness. In a former half of this process, an attachment of the engaging element E to the fastener tape T is completed, and the fastener stringer S is pulled up immediately after the clamping punches 13, 13 leave the legs of the engaging element. When the engaging head of the engaging element E leaves the forming die 5, the first ram 2 begins to retract. Thus, the attached engaging element is never caught by the forming die 5 which is retracted by the first ram 2.

The linear material W is cut by a retraction of the first ram 2. At this time of the retraction, pulling up of the fastener stringer S is completed. When the first ram 2 is located at its retraction position so that the engaging head is formed, the clamping punches 13 are actuated so as to nip the engaging element E from both sides via the legs. After the attachment of the engaging element by the clamping punches 13 is started halfway of the advancement of the first ram 2, the first ram 2 advances to a front end stop position, and hereinafter, the above-mentioned steps are repeated.

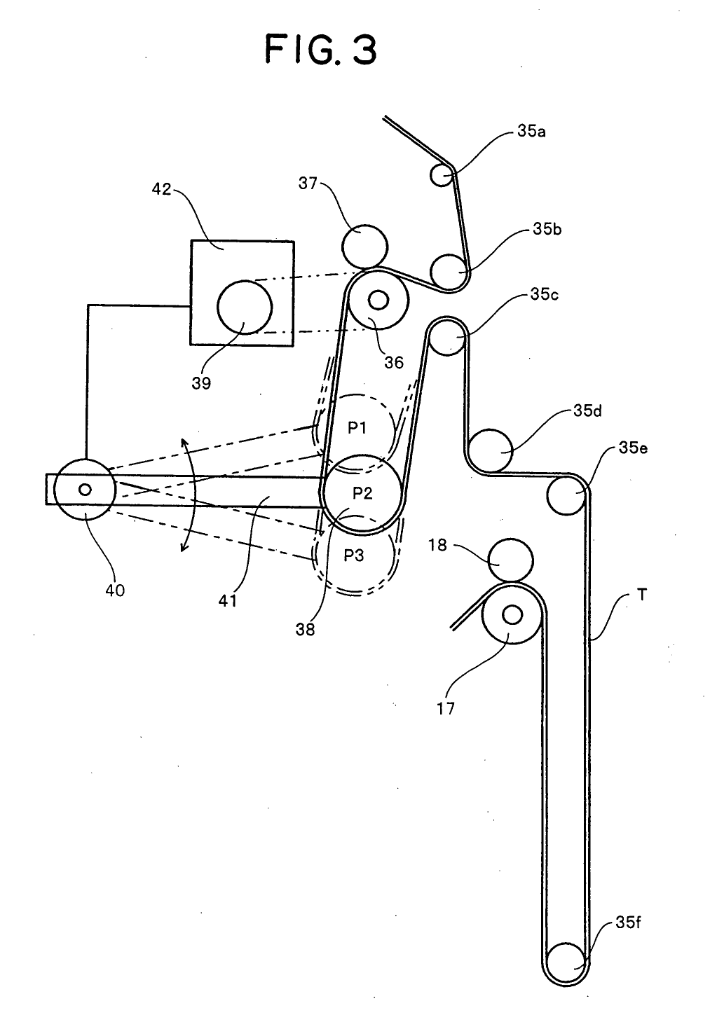

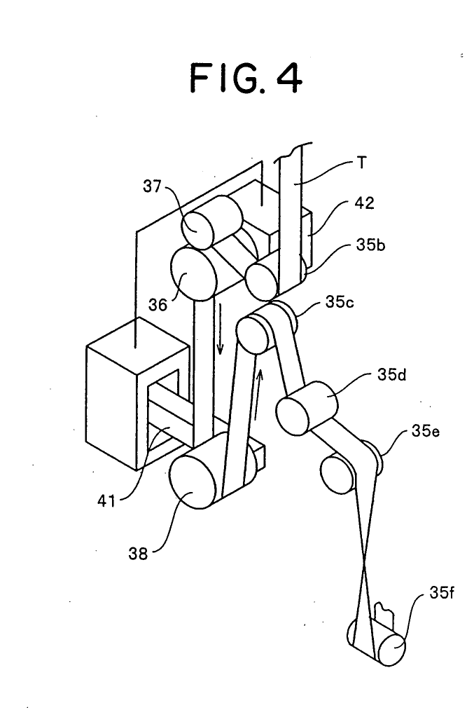

FIGS. 3 and 4 schematically show a tape feeding mechanism up to the intermittent drive roller 17 and the pressure roller 18 of the intermittent feeding portion of the fastener tape supply unit of the present invention. These figures show a feeding mechanism for the fastener tape T on a single side. However, a pair of each of rollers and drive motors including the dancer rollers, for the right and left, are disposed in order to treat two right and left fastener tapes T at the same time. Representation of cans, bobbins and the like, which are supply sources of the fastener tape T, is omitted.

The fastener tape T is guided by the first and second guide rollers 35a, 35b from a fastener tape supply source (not shown), and is pulled out positively between the drive roller 36 and the pressure roller 37 in a feed roller portion. At this time, the drive roller 36 is rotated at a constant speed while a dancer roller 38 described later swings up and down in a predetermined swing range. For example, a servo motor 39 is used for driving the drive roller 36. On the other hand, the fastener tape T is pulled up by the intermittent drive roller 17 and the pressure roller 18 in the intermittent feeding portion each time when the engaging element is attached while being guided by the tape guide 16 in the engaging element implantation portion through third to sixth guide rollers 35c to 35f disposed on a tape downstream side. Then, a completed fastener stringer S is fed to a next process.

The dancer roller 38 is disposed movably up and down between the third guide roller 35c disposed in the tape downstream side of the drive roller 36 and the feed roller portion. The dancer roller 38 of this embodiment is mounted rotatably on a shaft portion at a front end of a swing lever 41 which moves up and down and whose one end is journaled by a frame (not shown) through a rotary encoder 40. An output signal from the rotary encoder 40 is sent to a control portion 42. When a swing angle of the swing lever 41 goes out of a predetermined range of a swing angle, a control signal of rotation speed is outputted to the servo motor 39 which is a drive source of the drive roller 36 in a comparison circuit of the control portion 42. According to this embodiment, the rotary encoder 40 is employed so as to detect a rotation position of the dancer roller which moves up and down by a swing of the swing lever 41. Instead of the rotary encoder 40, it is permissible to adopt another position sensor, for example, a potentiometer limit switch, a photoelectric sensor, or a proximity switch. If such a sensor, a limit switch, a photoelectric sensor or a proximity switch is adopted, the swing lever 41 may be excluded. It is preferable to use an absolute type rotary encoder capable of directly detecting a current angular position as the rotary encoder 40.

On the other hand, usually, the above-mentioned fastener stringer manufacturing apparatus to which the fastener tape supply unit of the present invention is applied is operated continuously for several dozen hours. Thus, the fastener tape T is also supplied continuously for the same time period. The fastener tape T is constituted of textile woven fabric. Even if quality control about a hardness is carried out, the fastener tape T composed of textile changes easily in uniformity and stretching property if the surrounding condition changes. Further, in order to attach the above-mentioned linear-material-made engaging element E to the fastener tape T by clamping, a bolder core thread than warp and weft for use in the fastener tape T is fixed along the engaging element attaching portion or fixed by weaving or knitting at the same time when the tape is woven or knitted. Even if, for example, the rotation speed of the drive roller 36 is constant, a feeding amount of the fastener tape T having such a character changes, although it is only a little, by receiving an influence of a difference in thickness in a tape width direction due to slippage between the rollers and existence of the core thread. A continuous long fastener tape T is accommodated such that it is thrown in whorls in a container such as a can. When the fastener tape T accommodated in this can is pulled out of the can, twisting is likely to occur. If this twisting is taken to the feed roller portion, its feeding amount is affected largely. Although a change in feeding amount is not so large if it is observed in a short time, this becomes a large amount of the change after several dozen hours or a day after continuous operation, thereby affecting the tension of the fastener tape T. Consequently, an attachment interval (pitch) between the engaging elements is changed and the continuous operation is disabled.

According to this embodiment, when a predetermined angular position (position P2 of FIG. 3) of the rotary encoder 40 is assumed to be reference position 0, an angular position of +α° is defined as an upper limit position (position P1 of FIG. 3) and an angular position of −α° is defined as a lower limit position (position P3 of FIG. 3). In this case, when the dancer roller 38 is located between +α° and −α°, no output signal is sent to the servo motor 39. If a central position of the dancer roller 38 is over the +α°, an acceleration signal is outputted to the servo motor 39, so that the servo motor 39 is accelerated to a preliminarily set rotation speed so as to increase the feeding amount of the fastener tape T by the feed roller portion. In addition, if the central position of the dancer roller 38 drops below −α°, a deceleration signal is outputted to the servo motor 39, so that the servo motor 39 is decelerated down to a preliminarily set rotation speed so as to decrease the feeding amount of the fastener tape T by the feed roller portion.

When the up and down moving angle of the dancer roller 38 goes out of a predetermined angular range of +α° to −α°, the dancer roller 38 is placed in a predetermined angular range of +α° to −α° by controlling the rotation speed of the drive roller 36. Thus, tension between the feed roller portion for the fastener tape T and the intermittent feeding portion can be always set constant. Consequently, a high quality fastener stringer S is produced, thereby manufacturing a high quality slide fastener.

What is claimed is:

1. A fastener tape supply unit of a continuous manufacturing apparatus for a fastener stringer for successively attaching engaging elements for a slide fastener to a fastener tape supplied intermittently at a predetermined pitch to an engaging element implantation portion, wherein the engaging elements are obtained by cutting a metallic linear material having a substantially Y shaped section supplied intermittently at right angle and forming it into a mountain-like shape, the fastener tape supply unit comprising:
a supply source of the fastener tape;
a feed roller portion for feeding the fastener tape positively and continuously from the supply source;
a dancer roller which is hung by the fastener tape fed continuously between the feed roller portion and the engaging element implantation portion and moves up and down corresponding to changes in tape tension;
an intermittent feeding portion which is disposed in a downstream of the fastener tape of the engaging element implantation portion and feeds the fastener tape intermittently;
detecting means for detecting a move upper limit position and a move lower limit position of the dancer roller; and
a control portion for, when the detecting means detects that the dancer roller reaches the move upper limit position and the move lower limit position or when the detecting means detects that the dancer roller escapes from a range defined by the move upper limit position and the move lower limit position, controlling a tape feeding amount of the feed roller portion so as to always keep the dancer roller within the range based on a detection signal.

2. The fastener tape supply unit according to claim 1, wherein the dancer roller is rotatably supported via a supporting shaft at one end of a swing member, the other end of the swing member is journaled at a fixed position, and the detecting means comprises a rotary encoder disposed at the one end of the swing member.
